(19) United States
(12) Patent Application Publication
(10) Pub. No.: US 2016/0264044 A1
(43) Pub. Date: Sep. 15, 2016

(54) VEHICLE SUN VISOR

(71) Applicant: FORD GLOBAL TECHNOLOGIES, LLC, Dearborn, MI (US)

(72) Inventors: Anna Miller HILL, Belleville, MI (US); Neal Randolph OSSTYN, Royal Oak, MI (US); Peter David Alexander JONES, Birmingham, MI (US)

(21) Appl. No.: 14/657,213

(22) Filed: Mar. 13, 2015

(51) Int. Cl. B60Q 3/02; H02J 7/02; F21L 4/08

(52) U.S. Cl. CPC B60Q 3/0269; F21L 4/08; H02J 7/025

(57) ABSTRACT

A vehicle sun visor is provided. The sun visor includes a base portion, a vanity minor, and a lighting arrangement that includes a power source. The vanity minor and the lighting arrangement are each detachably coupled to the base portion. The sun visor also includes a charger that is configured to recharge the power source of the lighting arrangement when the lighting arrangement is coupled to the sun visor.

### TECHNICAL FIELD

The present disclosure relates to sun visors for vehicles.

### BACKGROUND

In order prevent sunlight from distracting drivers, vehicles often include sun visors.

### SUMMARY

A vehicle sun visor is provided. The vehicle sun visor includes a base portion, a vanity mirror detachably coupled to the base portion, and a lighting arrangement. The lighting arrangement includes a power source that is detachably coupled to the base portion. The lighting arrangement and vanity minor are each separately detachable from the base portion.

A vehicle sun visor is provided. The sun visor includes a base portion, a vanity mirror, a lighting arrangement, and an inductive charger. The lighting arrangement includes a power source and is detachably coupled to the base portion. The inductive charger is configured to recharge the power source of the lighting arrangement when the lighting arrangement is coupled to the sun visor.

A detachable vanity case for a vehicle sun visor is provided. The detachable vanity case includes a lighting arrangement and an electrical circuit. The lighting arrangement includes a power source and is detachably coupled to the vanity case. The electrical circuit is configured to electrically connect with the detachable lighting arrangement. The electrical circuit also includes a secondary inductive charge coil configured to electrically couple with a primary inductive charge coil of the sun visor when energized to enable charging of the power source.

### BRIEF DESCRIPTION OF THE DRAWINGS

FIG. 1 is schematic diagram illustrating a first embodiment of a vehicle sun visor;

FIG. 2 is a schematic diagram illustrating an alternative embodiment of the vehicle sun visor;

FIG. 3 is an electrical diagram illustrating an electrical circuit for a lighting device and an electrical circuit associated with charging a power source of the lighting device;

FIG. 4 is an electrical diagram illustrating an alternative embodiment of the electrical circuit for the lighting device and the electrical circuit associated with charging the power source of the lighting device; and

FIG. 5 is an electrical diagram illustrating an alternative embodiment of the electrical circuit for the lighting device.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

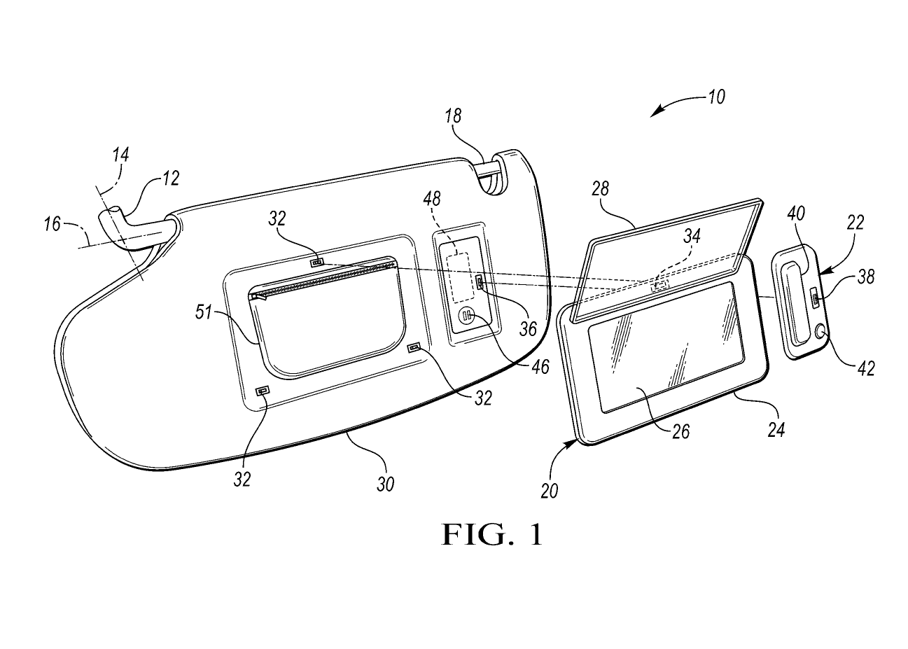

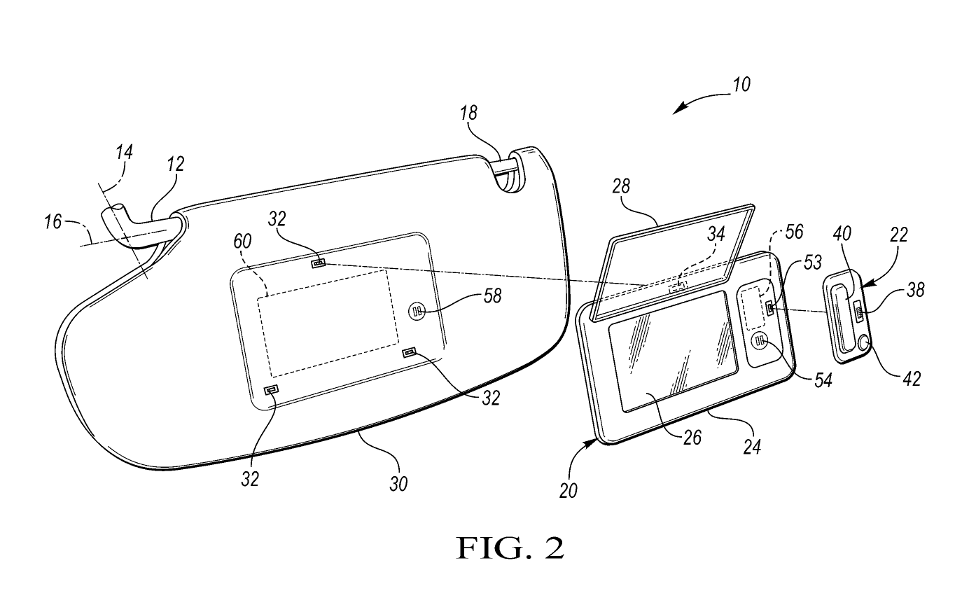

Referring to FIGS. 1 and 2 a sun visor 10 for a vehicle is illustrated. The sun visor 10 may include an attachment member 12 that connects the sun visor 10 to the interior of the vehicle. The sun visor 10 may be connected to interior trim components or portions of the vehicle frame. The portions of the vehicle frame that the sun visor 10 may be connected to include the roof cross members, roof rails, roof panel, A-pillar, B-pillar, C-pillar, D-pillar, or any other vehicle trim or frame component that is an appropriate location to mount a sun visor. The sun visor 10 may be adjustable. For example, the attachment member 12 of the sun visor 10 may be pivotally connected to the interior of the vehicle such that the sun visor pivots about a first axis 14 and a second axis 16. The sun visor 10 may also include a second attachment member 18 that is configured to attach to a clip or some other retaining mechanism that is also connected to the vehicle interior. The second attachment member 18 may be configured to prevent rotation about the first axis 14, while allowing rotation about the second axis 16, when the second attachment member 18 is attached to the clip or other retaining mechanism.

The sun visor 10 may also include a vanity mirror 20 and a lighting device 22. The vanity mirror 20 may include a backing portion 24 that supports a mirror portion 26. The vanity mirror 20 may also include a cover portion 28. The cover portion 28 may be configured to transition between an open position and a closed position. The cover portion 28 may be configured to cover the mirror portion 26 when in the closed position and expose the minor portion 26 when in the open position.

The lighting device 22 includes a lighting portion 40 and an on/off switch 42. The light may be generated by any conventional lighting source including incandescent lighting sources, fluorescent lighting sources, and LED (light emitting diode) lighting sources. The on/off switch 42 is configured to turn the lighting device 22 on or off. The on/off switch 42 may be any type of electrical switch. An additional switch may be provided that is configured to illuminate the lighting device 22 when the cover portion 28 transitions from the open position to the closed position.

The vanity mirror 20 may be configured to detachably couple to a backing portion 30 of the sun visor 10. A back side of the vanity mirror 20 may include one or a series of clips, hooks, snaps, or other attachment mechanisms that are configured to couple with a least one engagement mechanism 32 located on the backing portion 30 of the sun visor 10. The attachment mechanisms on the back side of the vanity mirror 20 may be configured to engage and disengage the engagement mechanisms 32 with a release mechanism 34. The release mechanism 34 may include a spring loaded release button. A user may disengage the attachment mechanism from the engagement mechanisms 32 with the release button in order to remove the vanity mirror 20 from the backing portion 30 of the sun visor 10. And, the spring in the release button may bias the attachment mechanism so that it remains coupled to the engagement mechanisms 32 when the vanity mirror 20 is coupled to the backing portion 30 of the sun visor 10.

The lighting device 22 may also be configured to detachably couple to the backing portion 30 of the sun visor 10. A back side of the lighting device 22 may include one or a series of clips, hooks, snaps, or other attachment mechanisms that are configured to couple with at least one engagement mechanism 36 located on the backing portion 30 of the sun visor 10. The attachment mechanism on the back side of the lighting device 22 may be configured to engage and disengage the engagement mechanism 36 with a release mechanism 38. The release mechanism 38 may include a spring loaded release button. A user may disengage the attachment mechanism from the engagement mechanism 36 with the release button in order to remove the lighting device 22 from the backing portion 30 of the sun visor 10, and the spring in the release button may bias the attachment mechanism so that it remains coupled to the engagement mechanisms 36 when the lighting device 22 is coupled to the backing portion 30 of the sun visor 10.

The backside of the lighting device 22 may also include an electrical connector 44 that is configured to engage an electrical outlet 46 located on the backing portion 30 of the sun visor 10 in order to provide power to the lighting device 22 or to recharge a power source of the lighting device 22 when the lighting device 22 is coupled to the backing portion 30 of the sun visor 10. Alternatively, an inductive charging device 48 may be utilized to provide power to the lighting device 22 or to recharge the power source of the lighting device 22. The inductive charging device 48 may include a primary coil 50 connected to the backing portion 30 of the sun visor 10 that is configured to induce electrical current into a secondary coil 52 connected to the lighting device 22 in order to provide power to the lighting device 22 or recharge the power source of the lighting device 22.

The backing portion 30 of the sun visor 10 may also include a storage pouch 51 located behind the vanity mirror 20 when the vanity mirror 20 is coupled to the backing portion 30 of the sun visor 10. The storage pouch may be made from a transparent material.

Referring now to FIG. 2, in the alternative, the lighting device 22 may be detachably coupled to the vanity minor 20 which is in turn detachably coupled to the backing portion 30 of the sun visor 10. The vanity mirror 20 and lighting device 22 combination may also be referred to as a vanity case. The lighting device 22 may be coupled to the vanity mirror 20 by one or a series of clips, hooks, snaps, or other attachment mechanisms that are configured to couple with at least one engagement mechanism 53, in the same manner that the vanity mirror 20 attaches to the backing portion 30 of the sun visor 10, as described above.

In the alternative embodiment in FIG. 2, the lighting device 22 may include an electrical connector that is configured to engage an electrical outlet 54 located on the vanity mirror 20 in order to provide power to the lighting device 22 or to recharge the power source of the lighting device 22 when the lighting device 22 is coupled to the vanity mirror 20. Alternatively, an inductive charging device 56 may be utilized to provide power to the lighting device 22 or to recharge the power source of the lighting device 22. The inductive charging device 56 may include a primary coil connected to the vanity minor 20 that is configured to induce electrical current into a secondary coil connected to the lighting device 22 in order to provide power to the lighting device 22 or recharge the power source of the lighting device 22.

The vanity minor 20 may in turn include an electrical connector that is configured to engage an electrical outlet 58 located on the backing portion 30 of the sun visor 10. Electrical power may then pass through an electrical circuit located in the vanity mirror 20 in order to provide power to the lighting device 22 through the electrical outlet 54 or inductive charging device 56. Alternatively, an inductive charging device 60 may be utilized to energize the electrical circuit located in the vanity mirror 20 in order to provide power to the lighting device 22 through the electrical outlet 54 or inductive charging device 56. The inductive charging device 60 may include a primary coil connected to the backing portion 30 of the sun visor 10 that is configured to induce electrical current into a secondary coil connected to the vanity minor 20 in order to energize the electrical circuit located in the vanity minor 20.

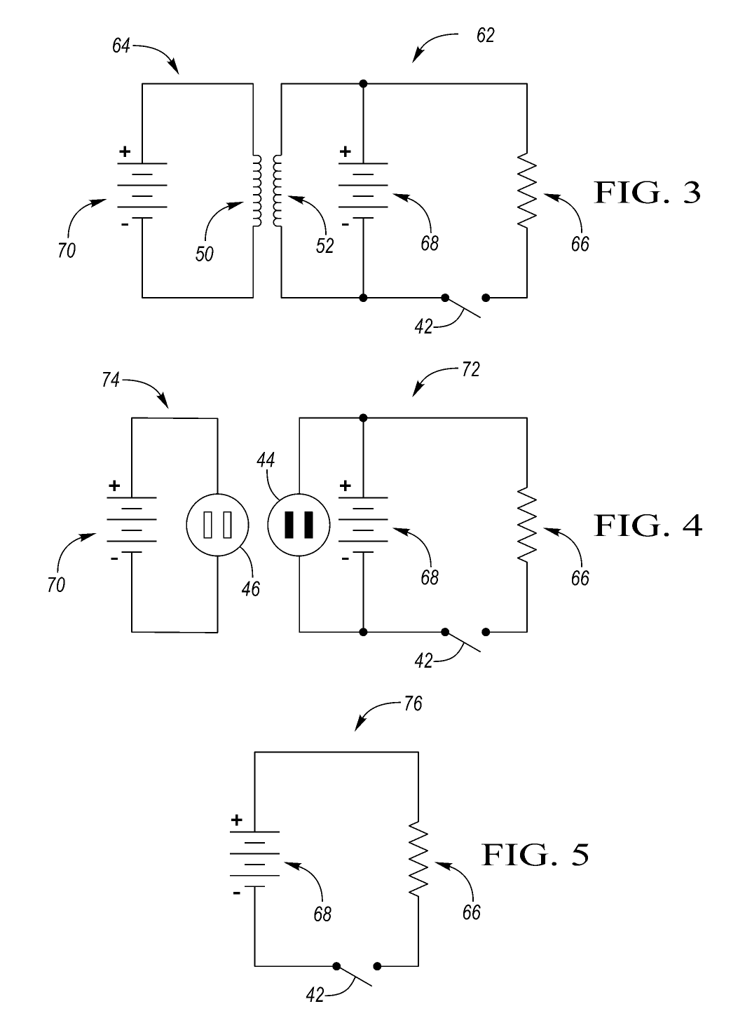

Referring now to FIGS. 3-5, electrical diagrams illustrating the electrical circuits of the lighting device 22 and electrical circuits associated with providing power to or charging the power source of the lighting device 22 are provided. The associated electrical diagrams in FIGS. 3-5 are representative of the electrical circuits that may be associated with the embodiment shown in FIG. 1. It should be understood, however, that the alternative embodiment depicted in FIG. 2 may be represented by incorporating the electrical circuit located in the vanity minor 20 into the electrical diagrams of FIGS. 3-5. As described above the electrical circuit in the vanity minor 20 provides an electrical connection from the electrical outlet 58 or inducting charging device 60, (located on the backing portion 30 of the sun visor 10) to electrical outlet 54 or inductive charging device 56 (located on the vanity mirror 20) in order to provide electrical power to the lighting device 22.

It should be further understood that the electrical diagrams in FIGS. 3-5 should not be construed as limiting. Some of the electrical components that are shown in series may be reconfigured so that they are in parallel, and some of the electrical components that are in parallel may be reconfigured so that they are in series. Additional electrical components that may be part of the larger overall electrical system of the vehicle may be incorporated without altering the scope of the disclosure.

Referring to FIG. 3, a first embodiment of an electrical circuit of the lighting device 62 and a first embodiment of an electrical charging circuit 64 are illustrated. The electrical circuit of the lighting device 62 includes the on/off switch 42, the secondary coil 52, a lighting source 66, and a power source 68. The power source 68 may include one or more batteries. The electrical charging circuit 64 includes the primary coil 50 and a primary power source 70. The primary power source 70 may include a battery that is part of the automobile electrical system. Alternatively, the power source may include an electrical generator, such as the vehicle alternator. The electrical charging circuit 64 is configured to provide power to the electrical circuit of the lighting device 62 in order to illuminate the lighting source 66 or recharge the power source 68. The primary coil 50 in the electrical charging circuit 64 provides power to the electrical circuit of the lighting device 62 by inducing electrical current into the secondary coil 52.

Referring to FIG. 4, a second embodiment of the electrical circuit of the lighting device 72 and a second embodiment of the electrical charging circuit 74 are illustrated. The electrical circuit of the lighting device 72 includes the on/off switch 42, the electrical connector 44, the lighting source 66, and the power source 68. The electrical charging circuit 74 includes the electrical outlet 46 and the primary power source 70. The electrical charging circuit 74 is configured to provide power to the electrical circuit of the lighting device 72 in order to illuminate the lighting source 66 or recharge the power source 68. Power is provided to the electrical circuit of the lighting device 72 when the electrical connector 44 is engaged with the electrical outlet 46.

Referring to FIG. 5, a third embodiment of the electrical circuit of the lighting device 76 is illustrated. The electrical circuit of the lighting device 76 includes the on/off switch 42, the lighting source 66, and the power source 68.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle sun visor comprising:
a base portion;
a vanity mirror detachably coupled to the base portion; and
a lighting arrangement, including a power source, detachably coupled to the base portion, wherein each of the lighting arrangement and vanity mirror is separately detachable from the base portion.

2. The vehicle sun visor of claim 1, further comprising a charger configured to recharge the power source of the lighting arrangement when the lighting arrangement is coupled to the sun visor.

3. The vehicle sun visor of claim 2, wherein the charger is an inductive charger.

4. The vehicle sun visor of claim 1, wherein the power source includes at least one battery.

5. The vehicle sun visor of claim 1, further comprising a storage pouch attached to the base portion.

6. The vehicle sun visor of claim 5, wherein the storage pouch is located between the base portion and vanity mirror when the vanity mirror is coupled to the base portion.

7. The vehicle sun visor of claim 1, wherein the lighting arrangement includes at least one light emitting diode.

8. The vehicle of claim 1, wherein the vanity mirror includes a cover that is configured to conceal the vanity mirror when in a closed position.

9. A vehicle sun visor comprising:
a base portion;
a vanity mirror detachably coupled to the base portion;
a lighting arrangement, including a power source, detachably coupled to the base portion; and
an inductive charger configured to recharge the power source when the lighting arrangement is coupled to the sun visor.

10. The vehicle sun visor of claim 9, wherein each of the lighting arrangement and vanity mirror is separately detachable from the base portion.

11. The vehicle sun visor of claim 9, wherein the lighting arrangement and vanity minor are collectively detachable from the base portion as a single unit.

12. The vehicle sun visor of claim 11, wherein the lighting arrangement is detachable from the vanity mirror.

13. The vehicle sun visor of claim 9, further comprising a storage pouch attached to the base portion.

14. The vehicle sun visor of claim 13, wherein the storage pouch is located between the base portion and vanity mirror when the vanity mirror is coupled to the base portion.

15. The vehicle sun visor of claim 9, wherein the lighting arrangement includes at least one light emitting diode.

16. The vehicle of claim 9, wherein the vanity mirror includes a cover configured to conceal the vanity mirror when in a closed position.

17. The vehicle of claim 9, wherein the power source includes at least one battery.

18. A detachable vanity case for a vehicle sun visor comprising:
a detachable lighting arrangement including a power source; and
an electrical circuit configured to electrically connect with the detachable lighting arrangement and including a secondary inductive charge coil configured to electrically couple with a primary inductive charge coil of the sun visor when energized to enable charging of the power source.

19. The vanity case of claim 18, wherein the lighting arrangement includes at least one light emitting diode.

20. The vanity case of claim 18, further comprising a cover configured to conceal a vanity mirror when in a closed position.
